(19) United States
(12) Patent Application Publication
(10) Pub. No.: US 2006/0277129 A1
(43) Pub. Date: Dec. 7, 2006

(54) System and method of transaction settlement and supply chain financing

(75) Inventors: Michael Lee Johnston, Wilton, CT (US); Tom Dunn, Dublin (IE)

Correspondence Address: SUGHRUE MION, PLLC, 2100 PENNSYLVANIA AVENUE, N.W., SUITE 800, WASHINGTON, DC, 20037, US

(73) Assignee: Orbian Corporation, Norwalk, CT (US)

(21) Appl. No.: 11/281,582

(22) Filed: Nov. 18, 2005

Related U.S. Application Data
(60) Provisional application No. 60/687,325, filed on Jun. 6, 2005.
(60) Provisional application No. 60/687,876, filed on Jun. 7, 2005.

(51) Int. Cl. G06Q 40/00

(52) U.S. Cl. 705/35

(57) ABSTRACT

In a system and method for obtaining financing to fund transaction settlements in a supply chain, the financing is obtained with a note, the proceeds of which are used to pay for purchase of one or more accounts receivable. The note is issued in one of the capital markets, and is secured by a substantially absolute obligation of only a single buyer to pay.

### CROSS-REFERENCE TO RELATED APPLICATIONS

This application claims the benefit of U.S. Provisional Application No. 60/687,325, filed Jun. 6, 2005, which is incorporated by reference, herein, in its entirety.

This application claims also the benefit of U.S. Provisional Application No. 60/687,876, filed Jun. 7, 2005, which is incorporated by reference, herein, in its entirety.

### FIELD OF THE INVENTION

The invention relates generally to supply chain financing. In particular, the invention relates to a system and method for obtaining financing to fund transaction settlements in a supply chain. More particularly, the financing is obtained with a note, the proceeds of which are used to purchase one or more accounts receivable. In one embodiment, the note is issued in a capital market, and is substantially secured by an obligation on a single account receivable related to a single buyer.

### BACKGROUND OF THE INVENTION

A significant issue in the business sector is the problem of late payments between customers and suppliers. While legislation has been enacted from time to time, for example, in the U.K. and in Europe, legislation has not solved the problem. An ideal solution to the problem would give commercial benefits both to the buyer and the supplier. Such a solution should work for both buyer and suppliers, as against a system or any sort of arrangement which might meet with or involve, for example, the supplier complaining about the buyer or demanding financial compensation from the buyer.

Typically, if the buyer pays earlier than the agreed invoice settlement date, then liquidity decreases for the buyer, and the supplier has benefited. Conversely, when the buyer pays later than the agreed settlement date, then the buyer's liquidity increases and the supplier's liquidity decreases. Any solution to the late payments problem must be mutually attractive to both buyer and suppliers and provide an answer to the conundrum of how to improve the liquidity of both the supplier and the buyer.

Attempts to address the problem of late payments have been made in the world of paper. The essence of such a paper-based system, is that when a supplier sends goods or services (hereafter, simply referred to as “goods” without loss of generalization) through to its buyer and subsequently sends the invoice, then along with the invoice is sent another paper instrument which is similar to a promissory note. This paper instrument is a very simple form of bill of exchange, which is accepted by the buyer for the value of the invoice and is sent back to the supplier. It is for the amount of the invoice and is normally expressed as maturing in a predetermined period, such as 90 days. The paper instrument then goes into circulation as a paper instrument from the supplier, for example, to the supplier's own supplier. In other words, the supplier can theoretically pass it on to its own supplier as means of settlement of indebtedness, so it moves as an instrument of value.

As the instrument in the example is paper, it is not divisible. More importantly, as it flows through the business community, each recipient has to form a judgment as to the credit worthiness of this particular instrument, and some, of course, go into default. The way the instrument is processed is that when it reaches maturity, the holder for value at that time presents it via the holder's own bank. Thus, the instrument finds its way back to the bank of the issuer, which is then either paid, or it goes into a default mode, or is protested under governing law. However, such paper instruments have a number of problems associated with their use, such as difficulties in transferability. They are not deliverable, and they are not really in any sense fungible, mainly because they are a wholly disparate credit family.

In U.S. Pat. No. 6,167,385 issued to Hartley-Urquhart on Dec. 26, 2000, there is described one approach to improving supplier chain transactions. In this approach, a third party such as a bank works with the buyer to establish the manner in which the bank can identify an acceptance on the buyer's part of goods provided by a supplier. When the bank notes that the buyer has accepted some goods, the bank calculates financing for the goods in a manner previously arranged between the parties. The bank pays the supplier, before the buyer's invoice has matured, a net amount that is discounted to account for the early payment and the cost of the financing. Upon maturity, the bank takes payment from the buyer.

The Hartley-Urquhart system is implemented on a computer system, and the payments are made via electronic commerce channels. This system, however, assumes the buyer never defaults, and does not take into account the possibility that the buyer might withhold partial payment, or reject the supplier's goods. Furthermore, this system does not explain how the bank obtains financing with which to make the payments to the suppliers in advance of the invoice maturing. A limitless supply of funds is assumed to be available to the bank.

Columns 1-9 and FIGS. 1-5 of the above-identified U.S. Pat. No. 6,167,385 is incorporated herein by reference, for the useful background information regarding supply chain problems and an attempted solution.

U.S. Pat. No. 5,732,400, issued to Mandler et al. on Mar. 24, 1998, describes a system and method for a risk-based purchase of goods. In Mandler, consideration is given to enabling on-line transactional services among sellers and buyers having no previous relationship. In this system, a financial clearinghouse is present on a computer communications network, and the clearinghouse receives requests from buyers for goods. The financial clearinghouse makes real-time determinations as to the credit worthiness of the buyer, involving a risk classification, based on available credit information.

After determining the risk classification, the clearinghouse determines a risk-based discount fee to decide a payment amount to be paid to the seller from the clearinghouse. If the transaction is authorized by the clearinghouse, the seller is paid the payment amount (which has been discounted in accordance with the risk classification) and the buyer is invoiced by the clearinghouse for the full amount of the transaction.

The Mandler system takes advantage of electronic commerce channels, but works on the principle that the buyer has a line of credit with the clearinghouse. For each transaction, the clearinghouse freezes a portion of the line of credit of the buyer until the clearinghouse receives the payment. The Mandler system suffers from mostly the same deficiencies and weaknesses as the Hartley-Urquhart approach discussed above, and does not explain how the clearinghouse can finance the amounts paid to the suppliers.

Columns 3-17 and FIGS. 1-5B of the U.S. Pat. No. 5,732,400 are incorporated herein by reference for their useful background information on an electronically based approach to transactions between buyers and suppliers, and also for its description of the attempted improvement in handling risk in handling such transactions.

U.S. Pat. No. 6,073,104, issued to Field on Jun. 6, 2000, describes a system that was thought to allow healthcare providers to access the commercial paper market by selling their patient claims to asset-backed commercial paper conduits. The system pools together the claims of numerous patients in “periodic pools.” According to the Field approach, each pool is accompanied by information indicating the historic collection experience with the patients in the pool so that there is sufficient statistical information to make it possible to value the pool as an investment.

Since Field pools together numerous healthcare claims, the risk of default of any one single healthcare consumer is spread out, and so the securitization of the health care accounts receivable is possible.

The Field approach is hardly applicable, however, to supplier chains. One reason for this is that a given account receivable from one buyer does not provide any diversification to insulate an investor from default. Even combining a plurality of accounts receivable, from a single buyer, fails to achieve enough diversification to achieve securitization in the capital markets.

FIGS. 1-55 and columns 1-23 of the U.S. Pat. No. 6,073,104 are nonetheless incorporated herein by reference for their useful instruction on how to implement a computerized system that supports the securitization of a pool of accounts receivable.

U.S. patent application Ser. No. 09/626,838, filed in Jul. 27, 2000, and commonly assigned with the present application, describes a concrete implementation of an electronic accounts payable settlement system suitable for enabling registered suppliers and buyers to settle transactions using trade credits. In this application, liquidity in a supplier chain is improved by electronically tracking receivables and making the obligations to pay from individual registered buyers into divisible and transferable credits that a registered supplier can use to pay their suppliers. This approach does not, however, provide any solution as to how financing can be obtained to support the early but discounted payment of accounts receivable to suppliers, and provides no guidance as to how to make accounts receivable in a supplier chain system acceptable for anything like securitization. The entirety of application Ser. No. 09/626,838 is incorporated herein by reference for its useful background information relating to another computerized system for handling transactions in a supplier chain environment.

### SUMMARY OF THE INVENTION

One object of the invention, among others which will become clear after reading the description below, is to overcome the above-identified disadvantages of prior approaches by providing a system, for financing supplier chain transactions, having a capital markets funding structure.

In one embodiment, a note is issued in a capital market, the note being substantially secured by an obligation on an account receivable related to only a single buyer, and the note is satisfied when the note matures and the account receivable is paid by the buyer. Although the note is not diversified, it is based on a substantially unconditional obligation of the buyer to pay the account receivable, in which the buyer has waived legal defenses that could result in non-payment. The receivable has a definite amount and a definite payment date. Thus, the credit rating of the buyer can be applied to the note.

The invention is taught below by way of various specific exemplary embodiments explained in detail, and illustrated in the enclosed drawing figures.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1 is a simplified schematic diagram of a computer implemented system suitable for an embodiment of the invention.

FIG. 2 shows, in schematic form, an exemplary transaction initiation according to an embodiment of the invention.

FIG. 3 shows, in schematic form, the continuation of an exemplary transaction according to an embodiment of the invention.

FIG. 4 shows, in schematic form, a conclusion of an exemplary transaction according to an embodiment of the invention.

FIGS. 5, 6, and 7 show, in schematic form, the continuation of an exemplary transaction according to an embodiment of the invention.

FIG. 8 shows, in schematic form, a conclusion of an exemplary transaction according to an embodiment of the invention.

FIG. 9 shows, in schematic form, the role of the backup purchaser according to an embodiment of the invention.

### DETAILED DESCRIPTION

The invention will now be taught using various exemplary embodiments. Although the embodiments are described in detail, it will be appreciated that the invention is not limited to just these embodiments, but has a scope that is significantly broader. The appended claims should be consulted to determine the true scope of the invention.

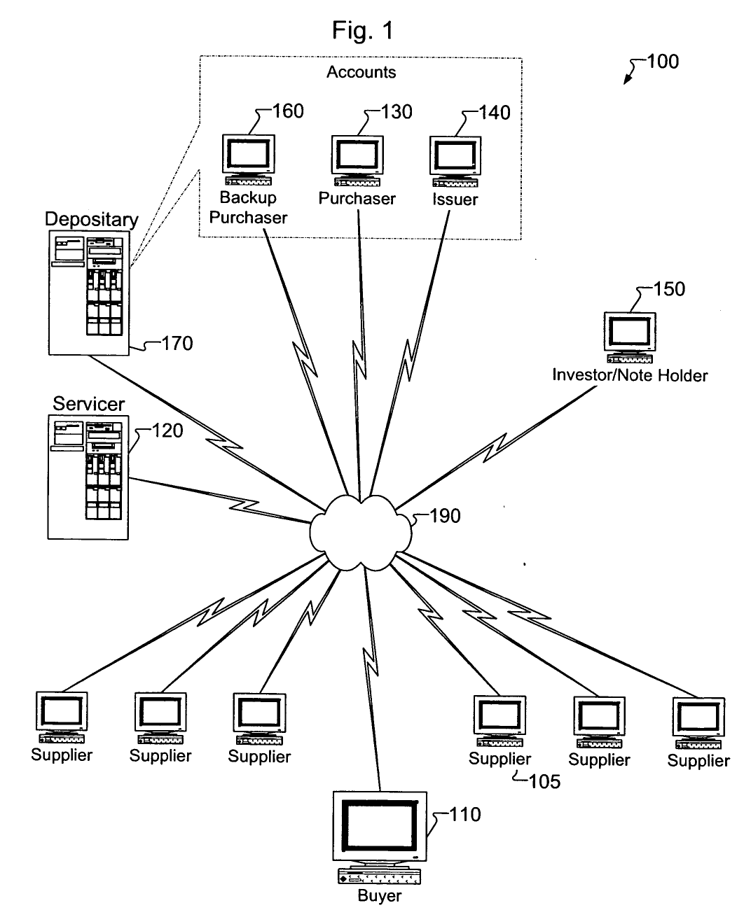

In FIG. 1, reference numeral 100 refers generally to a system for supply chain financing; reference numeral 105 refers to one or more suppliers; reference numeral 110 refers to an exemplary buyer; reference numeral 120 refers to a servicer; reference numeral 130 refers to a purchaser; reference numeral 140 refers to a note issuer; reference numeral 150 refers to an investor and/or note holder; reference numeral 160 refers to a backup purchaser; reference numeral 170 refers to a depositary; and reference numeral 190 refers to a communications network.

The suppliers 105 provide goods and/or services (hereinafter referred to simply as “goods” for the sake of convenience) to the buyer 110. The buyer 110 may, e.g., be a retail chain such as TARGET or WAL-MART, and the suppliers 105 may be companies that provide goods for the buyer 110 to sell. Likewise, each supplier 105 shown in FIG. 1 might be a buyer with respect to other companies, as is typical in a supply chain.

Note issuer 140 is herein described as issuing notes. As used throughout this description and in the appended claims, unless otherwise noted, the term “note” can take on not only its specific sense as used in capital markets, but also is meant to include the idea of debt instruments in general. Therefore, the term “note” as used herein should be understood in a broad rather than a narrow manner.

Each of the entities in system 100 is shown in electronic communication with each other over a suitable communications network 190 such as the Internet or any other network such as a virtual private network or the like.

The servicer 120 is shown with a specialized electronic accounts payable settlement system. The suppliers 105 and buyer(s) 110 are all registered with the system and agree to participate in the system 100 in accordance with predetermined rules and/or principles. The predetermined rules of participation will become evident through continued study of the discussion below. The specialized electronic accounts payable settlement system of servicer 120 is accessible by the suppliers 105 and buyer 110 via electronic communication, and appropriate login and security procedures are provided. As mentioned above, the specialized electronic accounts payable settlement system may be of the type mentioned in the related art documents, or of the type mentioned in the already discussed related patent application Ser. No. 09/626,838.

The communication among and between the entities shown in FIG. 1 can be according to specialized message traffic, or established financial communication channels, or may be performed in part using email or any other suitable form of communication known now or hereafter developed.

In FIG. 1, there is a rectangular box made with a chain-link line, with a point emanating from depositary 170. The box is annotated with the word, “accounts”. This illustration is intended to mean that the depositary 170, which may be a bank or the like, holds the funds in the accounts of the purchaser 130, the issuer 140, and the backup purchaser 160, but does not own the accounts. The presence of the depositary and its function of holding the funds in the accounts, which will be described more fully below, serves to reduce the risk of the investors. That is to say, the investors do not want to be exposed to the risk of the servicer, purchaser, issuer, and one way to reduce this risk is by way of the depositary holding the funds in trust, in accordance with the operations described throughout the remainder of this explanation. The role of the depositary will not be further mentioned in any substantial manner, but it will be appreciated that the transfer of funds is performed with respect to accounts controlled by the depositary but owned by one or more of the various entities shown in FIG. 1. It will also be understood that one or more accounts of investors may be at the depositary.

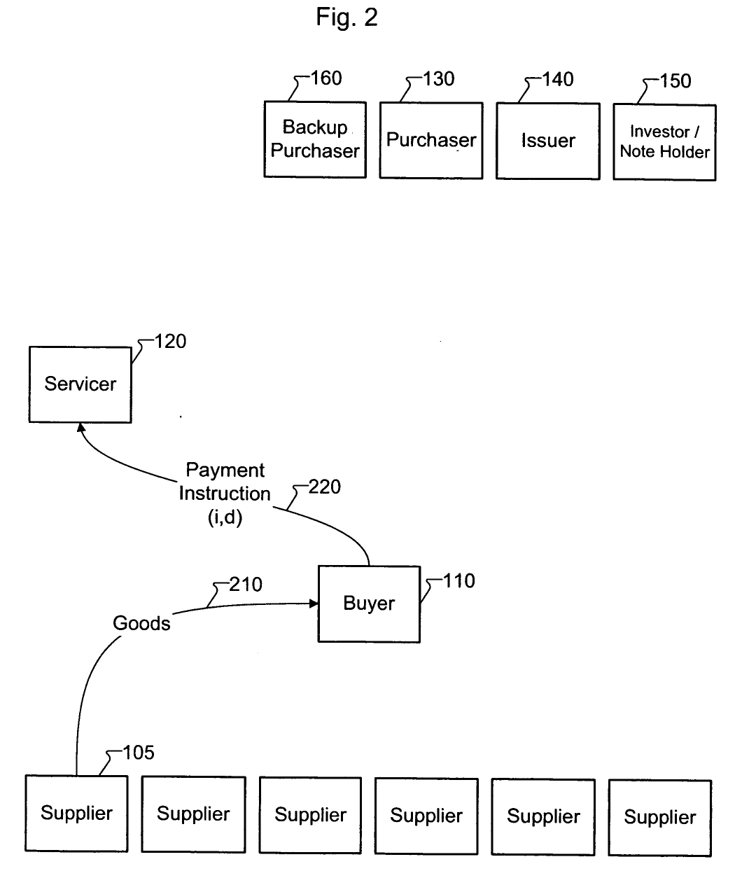

In general, two types of interactions are shown in FIGS. 2-9. In one type of interaction, there is a communication of information such as an instruction or other type of message. In another type of interaction, there is a transfer of funds. It will be appreciated that the handling of the instructions and messages is typically performed by the servicer 120 in cooperation with other computer systems of the other entities, and the handling of the transfer of funds is typically performed by the depositary 170 in cooperation with other banks or institutions of the other entities.

It will be appreciated that, although the servicer, the backup purchaser, the purchaser, the issuer, and the depositary are shown as separate entities, other arrangements are possible. For example, it is contemplated that one parent company might have responsibility for more than one of these functions. That is to say, one parent company might have wholly owned subsidiaries that separately handle the functions of servicer, purchaser, backup purchaser, issuer, etc. The foregoing functions may be thought of, collectively, as the functions of a financial intermediary. In a preferred embodiment, the financial intermediary and the depositary are distinct entities, so as to minimize the exposure of investors to the risk of the financial intermediary.

The specific details of a concrete implementation of the specialized electronic accounts payable settlement system will depend on numerous factors that are well known and form no part of this application. For example, the system may be built on four layers of application components configured to provide high-volume, secure and robust transaction processing. Those familiar with this field will readily understand the various layers of the ISO/OSI model. Adjacent layers may be separated through security control points, implemented in high-availability firewalls. A presentation layer may be based on multiple Apache web servers and communicate directly to the Internet to allow customers to connect to the specialized electronic accounts payable settlement system. A data transformation layer may be provided as a bespoke JAVA application running in clustered J2EE servers to control user access, create the user interface screens and interpret transaction data ready for processing. A transaction layer may be based on SAP financial-processing, accounting and cash management software supplemented by additional developed software. A relational database layer may be designed to attempt to guarantee the integrity and persistence of the data. The production system may be implemented so that, at each point in the infrastructure, there are multiple devices that are designed to attempt to automatically provide seamless recovery from single component failure. The system may operate with two or more physically separate data centers. In a primary data center, there may be housed the production and development systems. At a secondary data center, there may be disaster recovery and customer test systems. Full continuity of business and disaster recovery tests may be periodically performed.

Turning now to FIG. 2, many of the identical entities from FIG. 1 are depicted, although the particular underlying technology is omitted for the sake of simplified explanation.

In FIG. 2, a given supplier 105 has committed to supply certain goods 210 to the buyer 110. The buyer will pay an invoice amount i in a predetermined number of days d. When the buyer 110 approves the invoice of the supplier 105, the buyer 110 sends an electronic payment instruction message 220 to the specialized electronic accounts payable settlement system of the servicer 120. The payment instruction 220 indicates that the buyer 110 will pay 100% of the invoice amount i in d days.

It will be understood that every buyer 110 and every supplier 105 participating in the system 100 is at some point registered in the system through a registration process that is not depicted in the drawing figures. According to such a registration process, the buyer 110 or supplier 105 must agree to certain predetermined principles and/or rules. These predetermined principles and/or rules may be memorialized in a contract that governs the behavior of the buyers 110. For the sake of linguistic convenience, such predetermined principles and/or rules may hereafter be simply referred to as “rules”.

The payment instruction is governed by the rules. The payment instruction is an obligation from the buyer to pay the determined sum i. To ensure payment, the contract between the buyer 110 and the servicer preferably include provisions that make the buyer's obligation substantially absolute. For example, the rules may contain provisions that require the buyer to waive any rights the buyer may have to setoff the amount indicated by the payment instruction because of defective goods or the like. That is to say, preferably, the buyer 110 has to pay regardless of any dispute between the buyer 110 and supplier 105 once the payment instruction 220 is sent to the servicer 120. The payment instruction may be understood to be conveyed in a payment instruction message (also at reference numeral 220).

In one embodiment, the buyer's obligation may be absolute and unconditional instead of substantially absolute.

The rules of the system may provide for alternative recourse outside of the payment instruction 220 to seek relief from the supplier 105. Accordingly, the servicer 120 has a right to payment that is substantially absolute.

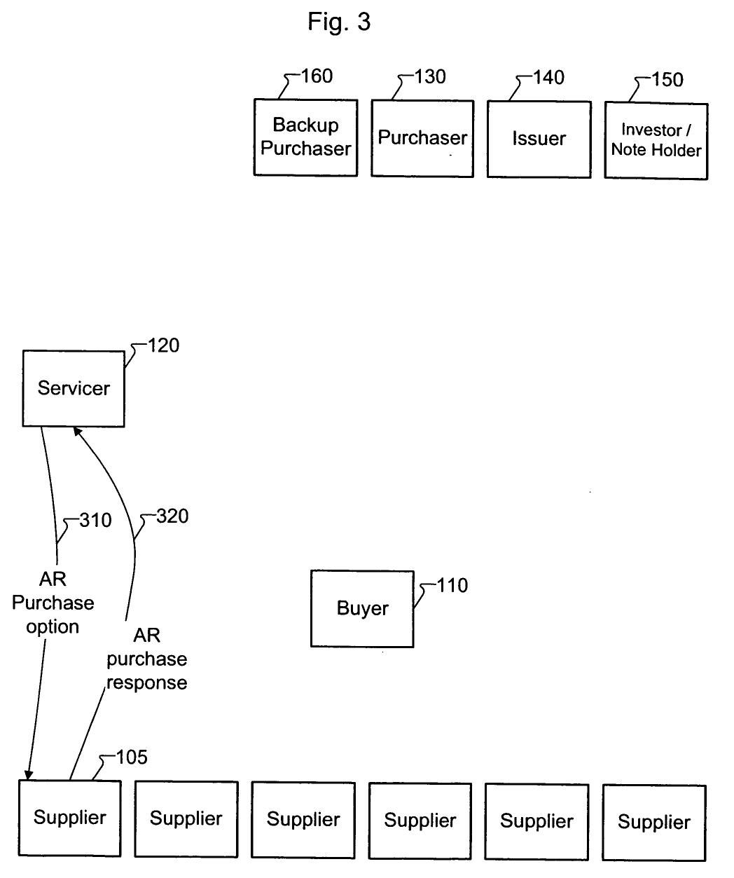

Turning now to FIG. 3, once the payment instruction 220 is properly accepted in the specialized electronic accounts payable settlement system of servicer 120, an accounts receivable (AR) purchase option message 310 is sent to the supplier 105. The supplier 105 may elect to sell to the purchaser the right to receive the payment i for the AR in d days, in exchange for a sum now that is less than i. On the other hand, the supplier 105 may decline the opportunity to sell the AR and decide to receive 100% of the payment amount i in d days. The decision of whether to sell or not sell the AR is provided to the servicer 120 in an AR purchase response message 320.

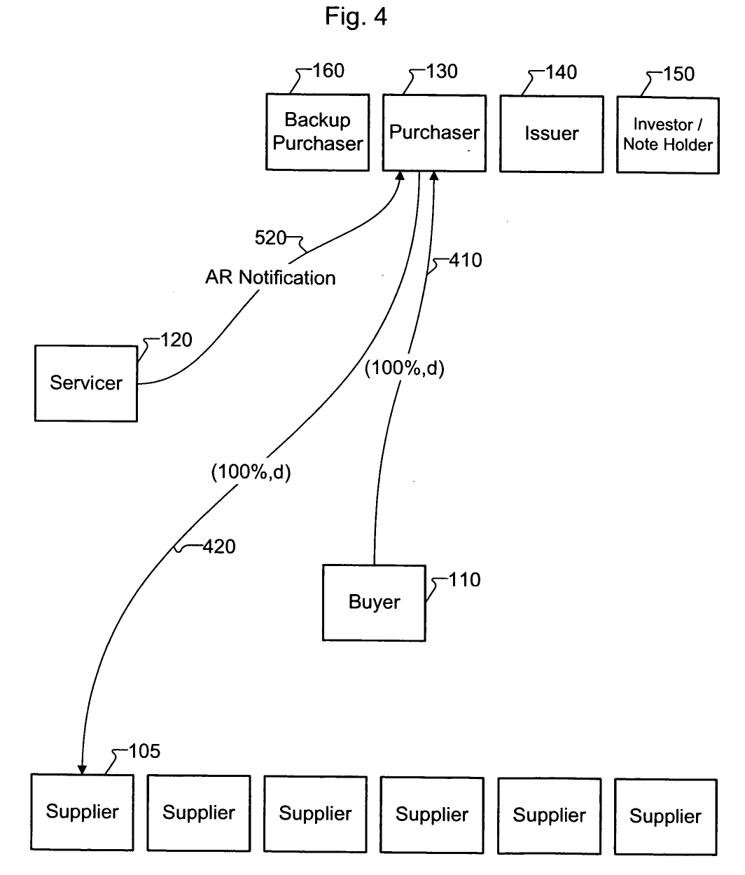

FIG. 4 shows the scenario in which the AR purchase response message 320 is in the negative (i.e., the supplier 105 elected to not sell the AR). The intent of the supplier 105 is conveyed by the servicer 120 to the purchaser 130 in an AR notification message 520. In this scenario, the buyer 110 pays 100% of the invoice amount i, after d days (see payment 410), into an account owned by the purchaser 130. Payment is made from the purchaser 130 to the supplier 105 (see payment 420). The supplier 105 is not paid from any kind of reserve, but is paid from funds provided by the buyer 110. The supplier 105 is thus paid only after the buyer 110 provided the funds. By paying the supplier 105 with the funds from the buyer 110, the need for a reserve is avoided. This concludes the transaction.

Of course, a fee for handling the transaction may be included in any number of ways so that the financial intermediary is properly compensated. In one preferred embodiment, the fees are borne either entirely or in the main by the suppliers.

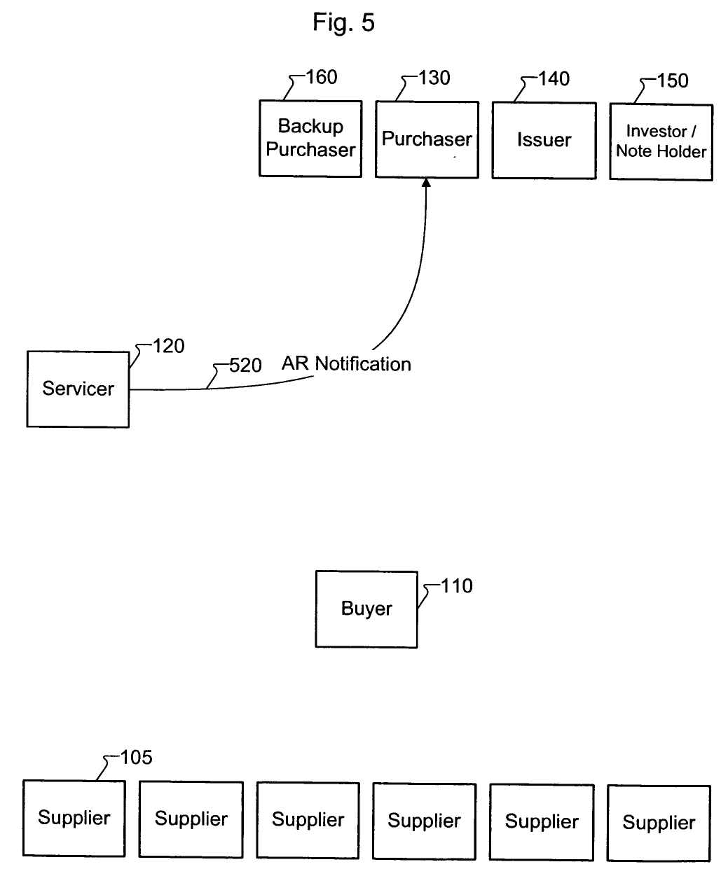

FIG. 5 shows the scenario in which the supplier 105 has sent an AR purchase response message 320 in the affirmative (i.e., the supplier 105 elected to sell the AR). The intent of the supplier 105 is conveyed by the servicer 120 to the purchaser 130 in an AR notification message 520. Although not shown, the servicer 120 is not obligated to purchase an AR, and may decline purchasing the AR. In a preferred embodiment, the purchaser 130 can refuse purchase of the AR until a later point in the process, but this will be discussed in more detail below. FIG. 5 assumes the servicer 120 has decided to purchase the AR (although, as just explained, in one preferred embodiment, this purchase decision could be a tentative purchase decision that is reversible).

In FIG. 5, the servicer 120 has not yet made any payment to the supplier 105. The payment, when it is made, will not be the full amount i of the invoice. Instead, the payment will be for an amount less than the full amount. The reason the payment will be for less than i is that the supplier 105 will be paid at a time much sooner than d days. Thanks to the automation of the program and the special attributes of the payment instruction, among other things, the payment can typically be made within about 48 hours. In the present example, it will be assumed that the early payment provided to the supplier 105 will be 85% of i. This figure of 85% is not intended to be limitative or even exemplary, and is provided for only the sake of instruction and explanation of the invention by way of a highly simplified example.

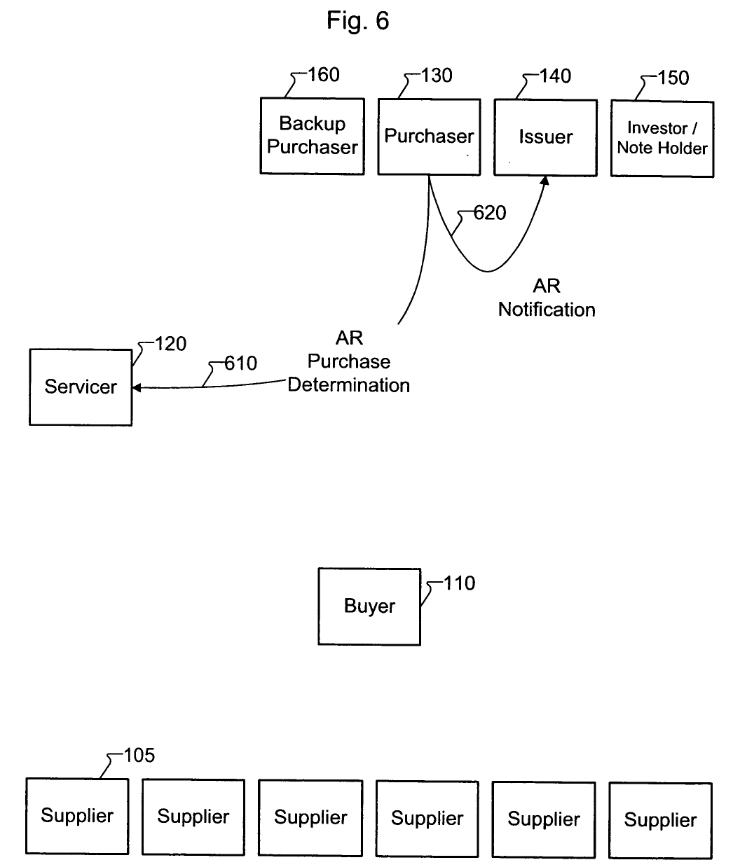

In FIG. 6, the purchaser 130 notifies the servicer 120 that the purchaser 130 will (at least tentatively) purchase the AR. The notification is made by way of an AR purchase determination message 610 and is passed on to the supplier 105 in a message not illustrated.

The purchaser 130, having decided to purchase the AR, notifies issuer 140 by way of an AR notification message 620.

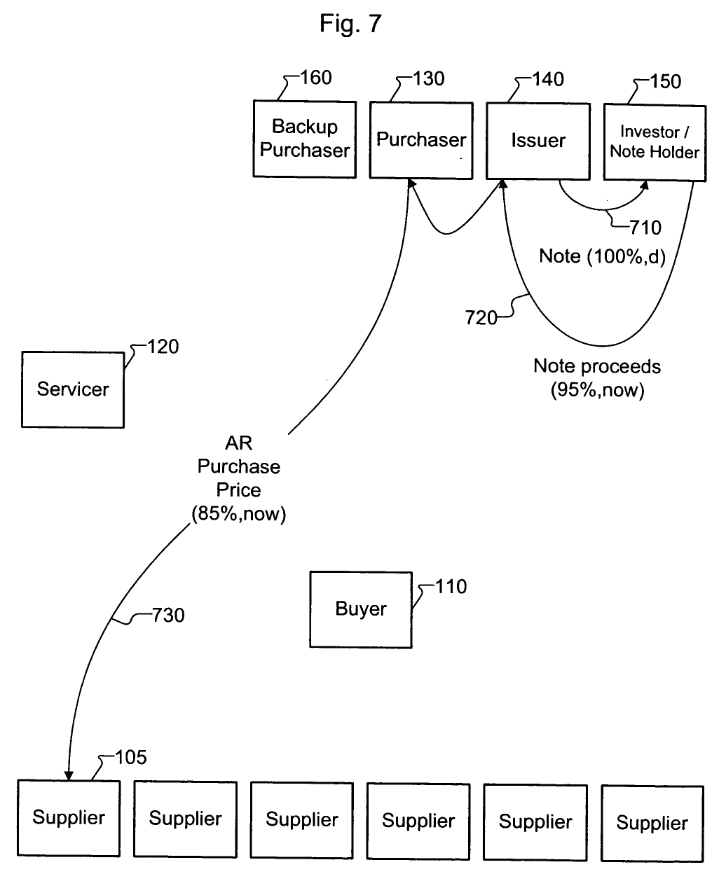

In FIG. 7, issuer 140 issues a note 710. The note 710 may for example be for 100% of the invoice amount i, and matures in d days. The note may be issued in the capital markets. The note 710 may have a rating from a recognized rating body. The recognized rating body can rate the note 710 because it represents a substantially absolute obligation by buyer 110 to pay the amount i in d days. The substantially absolute obligation, together with the certainty in the amount being paid and the date on which payment will be made, allows the rating body to give the note a credit rating based on the credit rating of the buyer 110. Take, for example, the situation in which buyer 110 is a national retail company such as WAL-MART. The absolute obligation of WAL-MART to pay a sum certain on a date certain can be given a very creditworthy rating at present. Thus, even though the note relates to a single receivable that is not diversified at all, and in fact relates to only one buyer, the note is sufficiently credible to be securitized in the capital markets. It will be appreciated that, as well, the note is secured not only by the obligation of the buyer 110 to pay, but also in part by the goods themselves. The credit rating of the buyer may be obtained by electronic communication with the rating body, in a manner known. The rating information may be stored by the issuer 140 or the servicer 120 in a computer storage for use when issuing the note 710.

It is foreseen that not every note will necessarily be rated. That is to say, in one embodiment, the note is unrated. An unrated note may not have a credit rating from a rating body.

Unrated notes may, however, still be acceptable to investors. It will be understood that the acceptability may arise in the following manner. Credit ratings, after all, are just ratings provided by third parties to help investors gauge the risk involved in a debt instrument. Where the buyer 110 is a major corporation whose risk is either well known or easily ascertainable (e.g., WAL-MART or FORD), the importance of a credit rating is less than the situation where the buyer 110 is relatively unknown. Where investors 150 can gauge the risk involved in the substantially absolute obligation of the buyer 110 to pay, the lack of a credit rating is relatively unimportant and so an unrated note can be issued.

Where a note is rated, it may be said that the note is a financial instrument that has a credit rating related to the credit rating of the buyer and also a credit risk that is related to the buyer's substantially absolute obligation to pay on the AR. Where a note is unrated, it may just be said that the note is a financial instrument that has a credit risk that is primarily just related to the substantially absolute obligation of the buyer to pay on the AR.

The note is sold in the capital markets to investors/note holders 150 for an amount that is in this example shown as 95% of the invoice amount i. The note proceeds 720 are paid now to the issuer 140, and are provided to the purchaser 130. Only 85% of i is paid to supplier 105 (see payment 730), the difference between the 95% received by the financial intermediary and the 85% paid to the supplier representing a profit to the financial intermediary. Here, as before, the cost of the program is borne by the suppliers in accordance with a preferred approach. It should be noted that the supplier 105 received no money from purchaser 130 until the funds were raised in the capital markets. This eliminates the need for a reserve of funds.

Above, it was noted that the purchaser 130, in one preferred embodiment, may make only a tentative decision to purchase the AR from the supplier. In particular, according to this embodiment, the purchaser can reverse such a tentative purchase decision until the note proceeds are received. This makes it possible for the purchaser to take into account any change in the creditworthiness of the buyer, or any difficulty in raising funds in the capital markets. If it happens that the purchaser ultimately decides not to purchase the AR, even after a tentative decision to purchase was made, the supplier is not damaged since it still has the right to 100% of i at the full d days term.

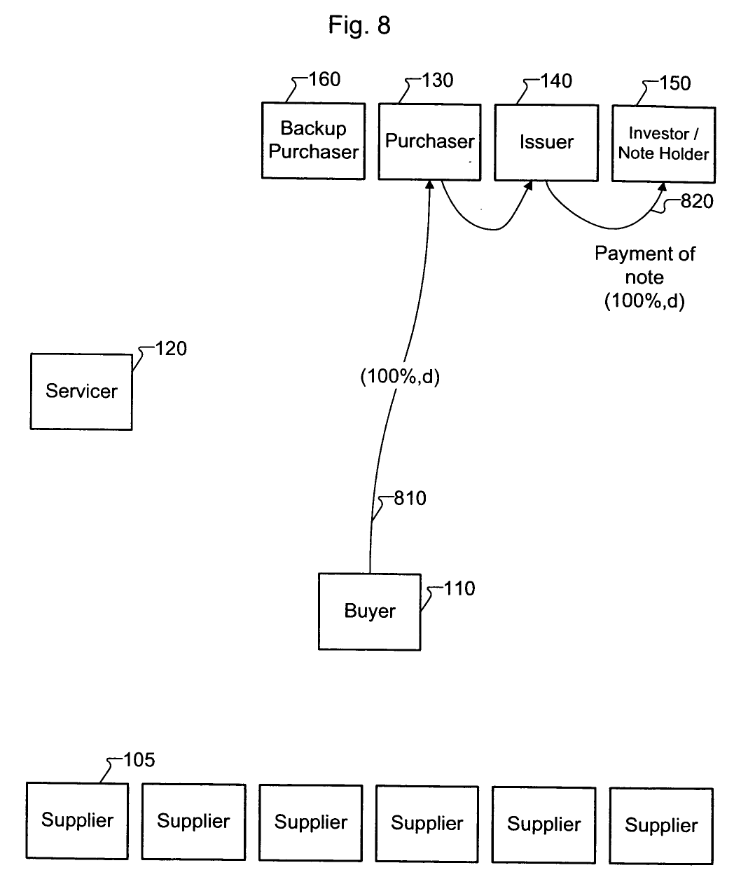

In FIG. 8, after d days, the obligation of the buyer 110 to pay i has matured. Buyer 110 makes a payment 810 of 100% of i, which is provided 820 ultimately to the investors 150 in satisfaction of the note, the payment of 100% of i at the date d of maturity.

Since the note holders 150 paid only 95% of the value to the issuer 140, but received 100% of the value after d days, the note holders 150 benefited by the difference, namely, 5% in this example. Therefore, the note holders 150 in this example received 5% interest on their investment.

Since the issuer received 95% of the value before maturation, and the servicer paid out 85% of the value to the supplier 105, there is a benefit before maturation of 10%, and this amount may go toward fees or profits to the participating entities. Such fees may include a depositary fee, a servicer fee, and the like. One advantage of the approach described above, indeed, is that it eliminates the need for the creation of a reserve or to provide over-collateralization. Since the note was financed by the capital markets, the collective financial intermediary did not need to have an unlimited supply of money to make it possible for the supplier to be paid now (i.e., in about 48 hours) for an amount that would not mature until d days.

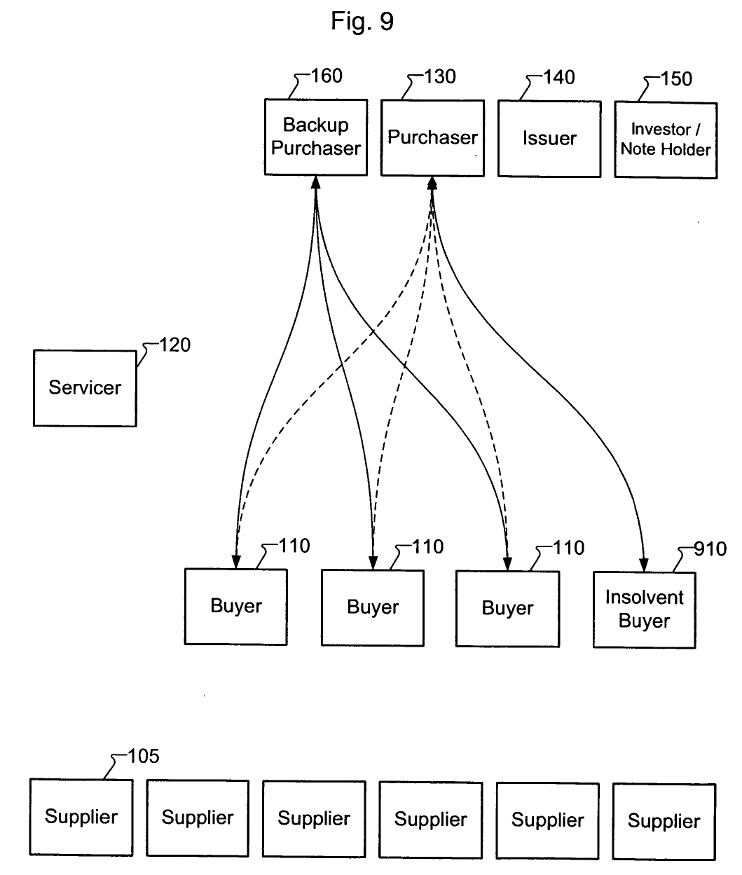

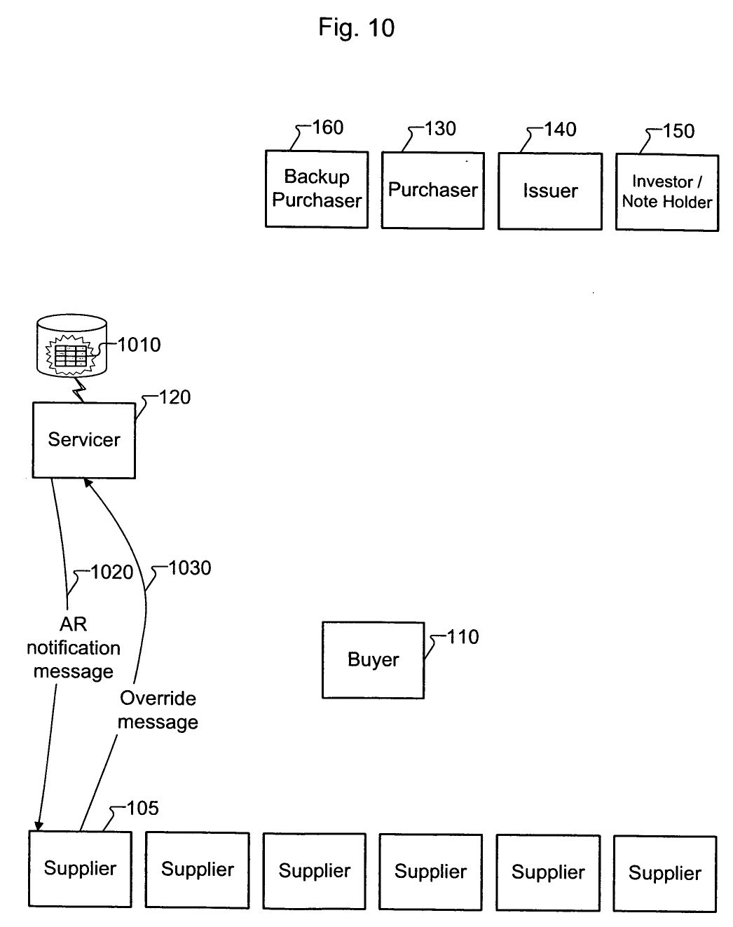

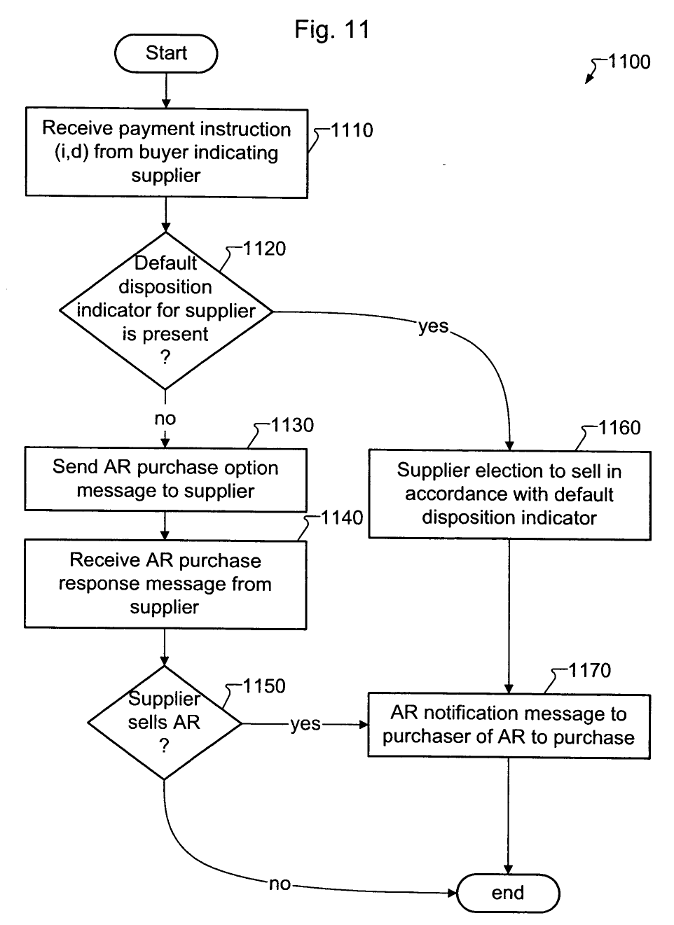

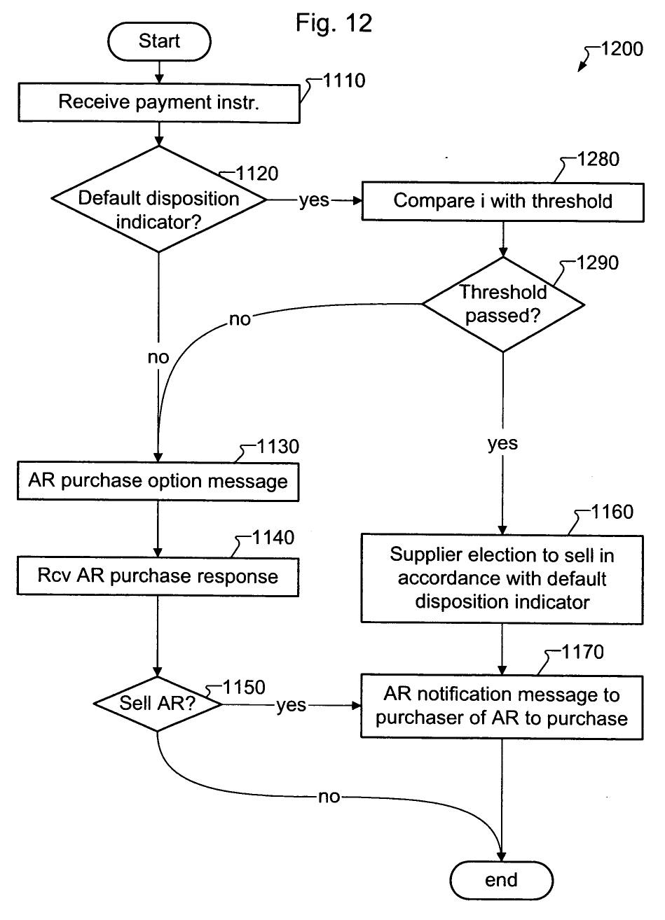

FIG. 9 helps to show the function of the backup purchaser 160. If any buyer 110 becomes an insolvent buyer 910, then the backup purchaser 160 assumes and performs with respect to all buyers 110 other than the insolvent buyer 910 the rights and obligations of the purchaser.

To the extent possible, the transaction is treated as a sale of a receivable (AR). However, if a buyer becomes an insolvent buyer, there is a possibility that the sale of receivables from the purchaser 130 to the issuer 140 might be recharacterized by a Court as a pledge to secure a borrowing. Then, a judgment, tax, or government lien on the Receivable might occur.

To minimize such effects, if any buyer becomes an insolvent buyer, the backup purchaser assumes the rights and performs the obligations of the purchaser, and all amounts on deposit except for those that might be subject to a government lien or the like, are transferred to new accounts of the backup purchaser.

In FIG. 9, this transfer of functions for the buyers 110 from the purchaser 130 to the backup purchaser 160 is depicted by dashed lines to show prior dealings and accounts between the buyers 110 and solid lines to show the relationships after the buyer 910 became insolvent.

The backup purchaser, therefore, helps ensure that the system 100 remains substantially remote from the possibility of effects from insolvency.

It will be understood that an important aspect of the system is the selection of buyers and suppliers. Since the particular implementation of such selection criteria forms no part of the invention, it will be appreciated that any risk mitigation criteria are expected to fall within the scope and spirit of the invention.

It will be appreciated that, although only one AR from buyer 110 was discussed, it is possible and foreseen that more than one AR from buyer 110 may be purchased by purchaser 130 and together made the subject of a note 710. This arrangement may be expressed, in the alternative, by saying that a note is issued in a capital market, the note being substantially secured by an obligation of a buyer with respect an account receivable (AR), wherein every AR securing the note relates to an identical buyer. This expression means that the note could be one AR or more than one AR, but all the ARs are from the same buyer 110. Also, “substantially secured” is a phrase that recognizes that the obligation to pay provides the main security, but the security interest in the goods (if that is the case) provided to the buyer 110 from the supplier 105 may be seen as providing some additional security.

It will be appreciated that, although only one note 710 was discussed, it is possible and foreseen that a series of notes may be issued by issuer 140.

It will be appreciated that, although no oversight for the system 100 has been described, it is possible and foreseen that an administrator and/or program manager function will be provided, and supported by appropriate electronic oversight computer applications.

Also, the servicer 120 may be thought of as a servicer computer system 120 (recall FIG. 1) that supports substantially all of the functions required by the purchaser 130, the issuer 140, the backup purchaser 160, and interface functions with the investors 150. That is to say, the servicer 120 may, for example, actually generate and communicate the existence of the note or notes 710 on behalf of the issuer.

Another alternative embodiment will now be discussed. It will be recalled that, in the discussion above with respect to FIG. 3, an AR purchase option message 310 was output by servicer 120 to supplier 105. The AR purchase option message 310 was sent so as to obtain the supplier 105 decision as to each AR. Under the present alternative embodiment, shown in FIG. 10, a default disposition 1010 with respect to the supplier 105 may be stored at the servicer 120.

More particularly, a default disposition indicator may be stored in a computer-readable record 1010 in the servicer computer system. The default disposition indicator 1010 may indicate that, for every given AR, the supplier 105 is automatically considered to authorize the purchaser 130 to purchase the AR (i.e., the supplier is automatically considered to elect to sell the AR). Under this alternative embodiment, it is unnecessary for the supplier 105 to send any AR purchase response message 320.

It will be understood that the default disposition indicator 1010 may on the other hand indicate that, for every given AR, the supplier 105 is automatically considered to elect not to sell the AR. In this case as well, it is unnecessary for the supplier 105 to send any AR purchase response message 320.

Moreover, in the foregoing alternative embodiments, where a default disposition indicator 1010 is used, it is not strictly necessary to send an AR purchase option message 310. Instead, a notification 1020 of the automatically elected AR sale or non-sale may be provided to the supplier 105. The notification 1020 may be by way of any electronic system, including the servicer computer system 120 or email.

FIG. 11 shows one concrete implementation of such an approach, at the servicer computer system. In FIG. 11, reference numeral 1100 generally indicates a process for handling payment instructions. In step 1110, a payment instruction 220 is received. In step 1120, a determination is made as to whether a default disposition indicator 1010, for the particular supplier 105 indicated by the payment instruction 220, is present.

When a default disposition indicator 1010 is not present, processing continues to step 1130 with the sending of an AR purchase option message 310 and the receipt of an AR purchase response message 320 as described earlier with respect to FIG. 3. Thereafter, a determination as to whether the supplier 105 elects to sell the AR is made based on the AR purchase response message 320.

When the determination indicates that the supplier 105 elects to sell the AR, processing continues to step 1170 where an AR notification 520 to the purchaser 130 is performed as shown in FIG. 5 and as previously described above to indicate an AR is available to purchase. When the determination indicates that the supplier 105 does not elect to sell the AR, processing continues to the end. Although not shown, the purchaser 130 may be sent an AR notification 520 indicating the AR is not available for purchase.

When a default disposition indicator 1010 is present, processing continues from step 1120 to step 1160. At step 1160, the supplier 105 is imputed with an intent to sell in accordance with the default disposition indicator 1010. That is to say, if the default disposition indicator 1010 indicates that the supplier 105 automatically sells every AR, then the supplier 105 is determined in this step to have elected to sell the particular AR being processed.

After step 1160, processing continues to step 1170, where the purchaser is sent a notification 520 that the AR is available for purchase.

Although not shown, at the time of steps 1160 or 1170, for example, the supplier 105 is sent an AR notification message 1020 so the supplier 105 is informed of the indication to the purchaser 130 of an AR automatically made available for purchase.

Moreover, in the foregoing alternative embodiments, where a notification 1020 of an automatically elected disposition of an AR is sent to the supplier 105, in accordance with a stored default disposition indicator 1010, it is foreseen that the supplier 105 may on occasion wish to override the action indicated by the default disposition indicator 1010. To facilitate such an override operation, the supplier 105 may send to the servicer computer system an override message 1030. Such an override message 1030 would have to be received by the purchaser 130 prior to the expiration of a time period of predetermined length. The reason for such a time period is that the purchaser 130 needs to be able to purchase the AR, when desired, with the confidence that the further processing will not be overridden.

Finally, it will be understood that it is possible that a default disposition indicator 1010 may be stored in association with a threshold indicator. The manner in which such a threshold indicator might be used is as follows. The threshold indicator is set to an amount, which defines a predetermined amount for the threshold. When a payment instruction 220 is received from the Buyer 110, the invoice amount i is compared with the threshold indicator. When the comparison shows the threshold is passed, the default disposition indicator 1010 is consulted. When the comparison shows the threshold is not passed, the default disposition indicator 1010 is not used, and the processing moves forward in the manner described already by way of an AR purchase option message 310 and an AR purchase response message 320 is consulted to obtain the supplier's election instead of the default disposition indicator 1010.

The foregoing embodiment involving a threshold is illustrated in simplified form in FIG. 12. More particularly, FIG. 12 shows an exemplary process for handling payment instructions 220 where a threshold is involved. The steps are similar to many of those described above with respect to FIG. 11, and these are not discussed again here.

After step 1120, when a default disposition indicator 1010 is determined to be present, the invoice amount i is compared with the threshold. If the amount i passes the threshold amount (i.e., passes it over or under the threshold, depending on the implementation) then processing continues to step 1160. Otherwise, processing continues to step 1130 so that the supplier 105 may make the election manually instead of automatically.

The precise implementation may vary, and the use of a threshold can be arranged so that invoices that are large require manual election by the supplier, or so that invoices that are small require manual election by the supplier. The most advantageous implementation will depend on the circumstances and the needs of the entities participating in the system.

It will be appreciated that the rules may vary, and that the contractual obligation of a buyer to pay may be further reinforced by providing the financial intermediary with the ability and/or duty to pursue predetermined enforcement procedures if the buyer fails to make a payment in accordance with the payment instruction. For example, the financial intermediary may refuse to accept further payment instructions from the buyer with respect to not only to the unpaid payment instruction of a single supplier, but with respect to any payment instruction for any of the suppliers. By refusing payment instructions with respect to all of the suppliers, not just instructions to the supplier that was not previously paid, the financial intermediary is able to leverage all of the suppliers of the buyer against the buyer to obtain payment.

In further embodiments, the system may rely predominantly on the buyer obligation to pay instead of the combined financed asset discussed above. In other embodiments, the financed asset may be purchased by a bank or financial institution or the financed asset may be the security for obtaining a favorable loan by the intermediary from the bank or financial institution. Alternatively, the financing based on the financed asset may come from the capital markets.

Additionally, in embodiments, the financial intermediary may issue short term notes in the capital markets secured by financed assets and the short term notes may be issued without external credit enhancement.

In the preceding embodiments, it has largely been stated that the notes are based on the substantially absolute obligation to pay of only one buyer 110. Even where more than one AR has been the subject of a note, it has been assumed that every AR is from the only one, identical buyer 110. Now, a different embodiment will be discussed in which the notes are based on the substantially absolute obligation to pay of more than one buyer 110.

Prior to this discussion, it will be helpful for the reader to appreciate the difference between this multiple buyer implementation of the invention and a pool of ARs as conventionally understood. In a pool of ARs as conventionally understood, the ARs are collected from a wide variety of buyers so as to reduce the risk of the buyers' failing or refusing to pay. In addition, the conventional pool of ARs are discounted and/or over-collateralized because that reduces the credit risk of the investor.

The conventional pool of ARs thus has a credit risk that is related not so much to the obligation of the buyers to pay as it is to the diversification of the buyer identities and the discounting/over-collateralization of the ARs.

In a multiple buyer embodiment of the invention, a note is based on the ARs of more than one buyer 110. Every buyer, however, is under the substantially absolute obligation to pay as was the case in the single buyer embodiments previously discussed. A note or series of notes according to the present embodiment may be based on ARs of multiple buyers 110 such as WAL-MART and FORD. According to this embodiment, every AR obligation securing the note relates to a substantially absolute obligation of the buyer with respect to an AR. Since every AR obligation is related to a substantially absolute obligation of the buyer to pay, there is no need for high diversification, and no need for over-collateralization. The credit risk in the multiple buyer embodiment is thus related to the obligation of the buyer to pay.

Compared with the conventional pool of ARs, the security in the multiple buyer embodiment of the invention is unique. Instead of the conventional security from diversification and over-collateralization (both of which assume a number or percentage of the ARs will be unpaid), the present embodiment provides security through the imposition of the substantially absolute obligation to pay, in accordance with the rules of participation in the system.

In the multiple buyer embodiment, the notes may be rated or unrated. The embodiment may be implemented in the manner set forth above with respect to any of the single buyer embodiments.

The financing may be enhanced, substantially unenhanced, or unenhanced.

Many variations to the above-identified embodiments are possible without departing from the scope and spirit of the invention. Possible variations have been presented throughout the foregoing discussion.

Combinations and subcombinations of the various embodiments described above will occur to those familiar with this field, without departing from the scope and spirit of the invention.

There is claimed:

1. A computer implemented method of financing a supplier in a supply chain, the method comprising:
issuing a note in a capital market, the note being substantially secured by an obligation of a buyer with respect an account receivable (AR), wherein every said AR obligation securing the note relates to an identical buyer; and
satisfying the note, when the note matures, with a payment from the buyer for the AR obligation;
wherein the AR is purchased from a supplier of the buyer; and
wherein the AR is indicated by a payment instruction from the buyer.

2. The computer implemented method of financing, as set forth in claim 1, wherein:
the payment instruction is sent from the buyer to a servicer computer system;
the servicer computer system sends an AR purchase option message to the supplier; and
the supplier responds to the AR purchase option message with an AR purchase response indicating whether the supplier requests to sell the AR.

3. The computer implemented method of financing, as set forth in claim 2, wherein the note is issued in the capital market only when the AR purchase response indicates the supplier requests to sell the AR.

4. The computer implemented method of financing, as set forth in claim 3, wherein:
the AR has an invoice amount i and a maturity date d; and
the supplier is paid an amount less than i, from proceeds of the note, prior to the maturity date d.

5. The computer implemented method of financing, as set forth in claim 1, wherein:
the payment instruction is sent from the buyer to a servicer computer system, and relates to the supplier; and
the servicer computer system, in response to the payment instruction, determines a supplier election to sell the AR based on a default disposition indicator.

6. The computer implemented method of financing, as set forth in claim 5, wherein the servicer computer system determines the supplier election to sell the AR based also on a comparison of an invoice amount i of the AR with a threshold.

7. The computer implemented method of financing, as set forth in claim 1, wherein the payment instruction relates to a substantially absolute obligation of the buyer to pay the AR.

8. The computer implemented method of financing, as set forth in claim 1, wherein:
the AR is purchased from the supplier by a purchaser; and
an issuer, cooperating with the purchaser, issues the note.

9. The computer implemented method of financing, as set forth in claim 8, wherein, in response to a buyer becoming an insolvent buyer, a backup purchaser assumes the rights and performs the obligations of the purchaser with respect to all buyers other than the insolvent buyer.

10. An instrument, intended for capital markets, comprising:
security from an obligation of a buyer with respect an account receivable (AR), every said AR obligation securing the note relating to an identical buyer and obtained by purchase from a supplier of the buyer;
a payment date and amount; and
a credit risk related to a substantially absolute obligation of the buyer to pay on the AR.

11. The instrument, intended for capital markets, as set forth in claim 10, further comprising a credit rating related to a credit rating of the buyer.

12. An instrument, intended for capital markets, comprising:
security from a plurality of obligations of a plurality of buyers with respect accounts receivable (ARs), defining a plurality of AR obligations;
every one of said plurality of AR obligations securing the note being related to one of said plurality of buyers;
every one of said plurality of AR obligations having a respective payment date and amount;
all of said plurality of AR obligations having a credit risk related to a substantially absolute obligation of one of said plurality of buyers to pay on the AR.

13. The instrument, intended for capital markets, as set forth in claim 12, further comprising a credit rating related to respective credit ratings of the buyers.

14. A computer implemented system, intended for performing a method of financing a supplier in a supply chain, the system performing the operations comprising:
receiving a payment instruction from a buyer, indicating a supplier identity, an invoice amount i, and a payment date d, wherein the payment instruction defines an account receivable (AR) from the buyer, and wherein the payment instruction represents a substantially absolute obligation of the buyer to pay the AR on the payment date;
determining an election of the supplier to sell the AR;
when the determination indicates the supplier elects to sell the AR, outputting an AR notification message;
receiving an AR purchase determination relating to the AR;
when the AR purchase determination indicates the AR is to be purchased, generating a note, for issue in a capital market, the note being secured by a substantially absolute obligation of the buyer with respect to the AR.

15. The computer implemented system, intended for performing a method of financing a supplier in a supply chain, as set forth in claim 14, wherein the determining of the election of the supplier to sell the AR is made by:
sending to the supplier an AR purchase option message; and
receiving from the supplier an AR purchase response indicating whether the supplier requests to sell the AR.

16. The computer implemented system, intended for performing a method of financing a supplier in a supply chain, as set forth in claim 14, wherein the determining of the election of the supplier to sell the AR is based on a default disposition indicator.

17. The computer implemented system, intended for performing a method of financing a supplier in a supply chain, as set forth in claim 16, wherein the determining of the election of the supplier to sell the AR is based also on a comparison of i with a threshold.

18. The computer implemented system, intended for performing a method of financing a supplier in a supply chain, as set forth in claim 14, further comprising:
obtaining a credit rating pertaining to the buyer; and
issuing the note with an indication of the obtained credit rating.

19. The computer implemented system, intended for performing a method of financing a supplier in a supply chain, as set forth in claim 14, wherein:
the note is secured by security from a plurality of obligations of a plurality of buyers with respect accounts receivable (ARs), defining a plurality of AR obligations;
every one of the AR obligations securing the note is related to one of the buyers;
all of the AR obligations have a credit risk related to a substantially absolute obligation of one of the buyers to pay on the AR.

20. The computer implemented system, intended for performing a method of financing a supplier in a supply chain, as set forth in claim 19, wherein the note includes a credit rating related to respective credit ratings of the buyers.
